(19) United States
(12) Patent Application Publication
(10) Pub. No.: US 2021/0135899 A1
(43) Pub. Date: May 6, 2021

(54) VEHICLE COMPUTER SYSTEM

(71) Applicants: INVENTEC (PUDONG) TECHNOLOGY CORPORATION, Shanghai City (TW); INVENTEC CORPORATION, Taipei City (TW)

(72) Inventors: Ye LIU, Shanghai City (CN); Jinjie WU, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/794,092

(22) Filed: Feb. 18, 2020

(30) Foreign Application Priority Data
Oct. 30, 2019 (CN) 201911046423.6

(51) Int. Cl. H04L 12/40; G06F 9/4401

(52) U.S. Cl. CPC H04L 12/40; H04L 2012/40273; G06F 9/4401

(57) ABSTRACT

A vehicle computer system, the vehicle computer system comprises a processor body structure and a processor auxiliary structure. The processor auxiliary structure is detachably connected externally to one side of the processor body structure. The assisting processor structure is configured to assist the processor body structure to improve the computing capability of the vehicle computer system.

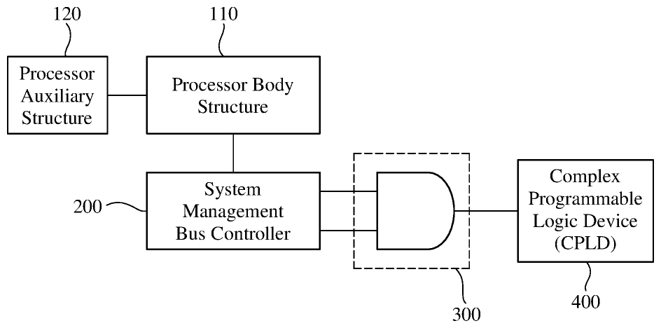

### CROSS-REFERENCE TO RELATED APPLICATIONS

This non-provisional application claims priority under 35 U.S.C. § 119(a) on Patent Application No(s). 201911046423.6 filed in China on Oct. 30, 2019, the entire contents of which are hereby incorporated by reference.

### BACKGROUND

### 1. Technical Field

This disclosure relates to a field of computer technology, particularly to a vehicle computer system.

### 2. Related Art

Autonomous vehicle, self-driving automobile, also known as a driverless vehicle, computer-driven vehicle, or wheeled mobile robot, is an intelligent vehicle that is unmanned by a vehicle computer system.

Current systems in vehicles need to sense their environment using techniques such as radar, optical radar, GPS and computer vision, with advanced control systems converting the sensed data into appropriate navigation routes, obstacles and related signs. In addition, the map information can be updated with the inputted sensed data, so that the vehicle can continuously track its own location. Therefore, the computing capability of the vehicle computer system is in great demand throughout the process. In order to meet the above requirements, the expansion card and the central processing unit are disposed together in the existing vehicle computer system to save space. However, the vehicle computer system occupies a large space. Particularly, the expansion card may not function fully when the vehicle computer system does not require such high computing capability. Furthermore, the space is wasted due to the integrated dispose of the expansion card and the central processing unit, which also increases the cost.

### SUMMARY

According to one or more embodiment of this disclosure, a vehicle computer system, comprising: a processor body structure; and a processor auxiliary structure detachably connected externally to one side of the processor body structure, the processor auxiliary structure is configured to assist the processor body structure to enhance a computing capability of the vehicle computer system.

Preferably, the processor body structure and the processor auxiliary structure are separated from each other and designed independently.

Further, the computing capability of the processor body structure is represented by a computing frequency, and the computing frequency is lower than or equal to 2.9 GHz.

Furthermore, when a need of the computing frequency of the vehicle computer system is lower than or equal to 2.9 GHz, the processor auxiliary structure is disconnected to the side of the processor body structure.

Furthermore, when a need of the computing frequency of the vehicle computer system is higher than 2.9 GHz, the processor auxiliary structure is connected externally to one side of the processor body structure.

Furthermore, the processor body structure comprises a central processing unit and a memory, the central processing unit is coupled to the memory.

Furthermore, the processor body structure has a first interface externally connecting the processor auxiliary structure, the processor auxiliary structure is inserted in the first interface.

Furthermore, the processor body structure has a second interface connecting a Next Generation Form Factor M.2, and a third interface connecting a peripheral interface, the third interface is configured to connect at least one of a USB or an Ethernet.

Furthermore, the system has a system management bus controller, a logic circuit, and a complex programmable logic device, the system management bus controller is coupled to the processor body structure; the logic circuit is coupled to the system management bus controller; the complex programmable logic device is coupled to the logic circuit.

Furthermore, the system has a system management bus controller, the system management bus controller generates a first signal and a second signal, wherein the first signal is configured to instruct a self-examining boot state of the vehicle computer system, the second signal is configured to instruct a default state.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

The sole FIGURE is a block diagram of a vehicle computer system according to an embodiment of the present disclosure.

### DETAILED DESCRIPTION

The present embodiment provides a vehicle computer system. The sole FIG. is a block diagram of the vehicle computer system. As shown in the sole FIGURE, the vehicle computer system comprises a processor body structure 110, a system management bus controller 200, a logic circuit 300, and a complex programmable logic device (CPLD) 400.

The processor body structure 110 performs functions or tasks related to automobile driving, for example, a connection with a vehicle bus system such as a controller area network (CAN), a media oriented system transport (MOST), control of the air conditioning, navigation, driver alarm system, analysis and display of 2D map used for navigation, audio output, human-machine interface. At the same time, the processor body structure 110 can further connects various kinds of application systems, such as internet connection, image application, navigation application. A computing capability of the processor body structure 110 is represented by a computing frequency, and the need of the computing frequency of the processor body structure 110 is smaller, for example, smaller than or equal to 2.9 GHz. The processor body structure 110 is coupled to the system management bus controller 200.

The vehicle computer system further comprises a processor auxiliary structure 120 detachably connected externally to one side of the processor body structure 110. The processor body structure 110 and the processor auxiliary structure 120 are electrically connected with each other when the processor auxiliary structure 120 is inserted at the side of the processor body structure 110 to increase the computing capability of the processor body structure 110, so that the computing frequency of the vehicle computer system is higher than 2.9 GHz. When the processor body structure 110 can meet the need of the computing capability of the vehicle computer system, the processor auxiliary structure 120 may not be connected externally to the side of the processor body structure 110. Accordingly, the processor body structure 110 and the processor auxiliary structure 120 are separated and designed independently (meaning they are designed separately), which reduces the volume of the vehicle computer system occupied by the processor body structure 110, and lowers the cost of the vehicle computer system. In addition, the processor auxiliary structure 120 won't be affected when an electrical abnormality or a physical abnormality occurs on the processor body structure 110, thereby reducing the chances that both the processor body structure 110 and the processor auxiliary structure 120 need to be repaired or scrapped.

The processor body structure 110 comprises a central processing unit (CPU) and a memory (Mem). The CPU is coupled to the memory. The processor body structure 110 further comprises a first interface externally connecting the processor auxiliary structure 120, a second interface connecting a Next Generation Form Factor M.2, and a third interface connecting a peripheral interface. The third interface, for example, connects a USB or an Ethernet. The processor auxiliary structure 120 is inserted in the first interface, and allow a general entertainment electronic equipment and a vehicle computer are connectable via the second interface and the third interface.

The system management bus controller 200 is coupled to the processor body structure 110. The system management bus controller 200 generates a first signal and a second signal, wherein the first signal is configured to instruct a self-examining boot state of the vehicle computer system, the second signal is configured to instruct a default state. In addition, the system management bus controller 200, for example, is a platform controller hub.

In this embodiment, the system management bus controller 200 can, for example, be used to detect the self-examining boot state of the vehicle computer system to generate the first signal configured to instruct a self-examining boot state of the vehicle computer system accordingly. For example, when the first signal is in a low level state, it indicates that the self-examining boot state of the vehicle computer system is a complete self-examining boot state. That is to say, the vehicle computer system has completed the self-examining and can operate normally. On the contrary, when the first signal is in a high level state, it indicates that the self-examining boot state of the vehicle computer system is an incomplete self-examining boot state. That is to say, the vehicle computer system may have abnormality and therefore needs to be reboot. In addition, the system management bus controller 200, for example, maintains the second signal, which is configured to instruct the default state, in high level state.

The logic circuit 300 is coupled to the system management bus controller 200 to receive the first signal and the second signal, and to generate a logic signal. Further, the logic circuit 300 is, for example, an AND gate to perform logic computing on the first signal and the second signal to generate the logic signal. For example, when the first signal and the second signal are in high level state, the logic circuit 300 performs logic computing on the first signal and the second signal that are in the high level state to generate, for example, the logic signal in the high level state. When the first signal is in the low level state and the second signal is in the high level state, the logic circuit 300 performs logic computing on the first signal which is in the low level state and the second signal which is in the high level state to generate, for example, the logic signal in the low level state.

Further, in this embodiment, the system management bus controller 200 has a first general purpose input output (GPIO) interface and a second GPIO interface. The first GPIO interface and the second GPIO interface are coupled to the logic circuit 300, and respectively generate the first signal and the second signal. In other words, the system management bus controller 200 outputs the first signal and the second signal to the logic circuit 300 via the first GPIO interface and the second GPIO interface, to provide the first signal and the second signal to the logic circuit 300 for subsequent computing.

The CPLD 400 is coupled to the logic circuit 300 to receive the logic signal, and generate a reboot signal of the vehicle computer system according to the logic signal. In the present embodiment, when the logic signal received by the CPLD 400 is in high level state, the CPLD 400 generates the reboot signal of the vehicle computer system, for example, the reboot signal in high level state, to reboot the vehicle computer system. Then, the vehicle computer system re-perform the self-examining boot test until the first signal generated by the system management bus controller 200 is in high level state, indicates that the vehicle computer system completes the self-examining boot test and can operate normally.

When the logic signal received by the CPLD 400 is in low level state, the CPLD 400 does not generate the reboot signal of the vehicle computer system, for example, the reboot signal in high level state, so that the vehicle computer system can operate normally.

In addition, in the present embodiment, the system management bus controller 200 can further receive the reboot signal. Moreover, the reboot signal is, for example, a CPU_thermtrip signal. In other words, the system management bus controller 200 can further learn the self-examining boot state of the vehicle computer system. For example, when the reboot signal is in high level state, it indicates that the vehicle computer system needs to be reboot. The system management bus controller 200 can learn that the self-examining boot state of the vehicle computer system is the incomplete self-examining boot state, and to further correspondingly generate the first signal in high level state. When the reboot is in low level state, it indicates that the vehicle computer system does not need to be reboot. Then, the system management bus controller 200 can learn that the self-examining boot state of the vehicle computer system is the complete self-examining boot state, and to further generate the first signal in low level state correspondingly.

In view of the above description, the vehicle computer system according to one or more embodiments of the present disclosure, the vehicle computer system comprises the processor body structure and the processor auxiliary structure. The processor auxiliary structure is detachably connected externally to the side of the processor body structure. The processor auxiliary structure is configured to assist the processor body structure to enhance the computing capability of the vehicle computer system.

Furthermore, the processor body structure and the processor auxiliary structure are separated from each other and designed independently (meaning they are designed separately). When the processor body structure can meet the need of the computing capability of the vehicle computer system, the processor auxiliary structure may be disconnected to the side of the processor body structure, which reduces the volume of the vehicle computer system occupied by the processor body structure, and lowers the cost of the vehicle computer system.

In addition, it should be noted that the descriptions of the terms “first”, “second” and the like in the specification are merely used to distinguish between the various components, elements, steps, etc. in the specification, unless specifically stated or indicated, instead of indicating the logical relationships or orders between the various components, elements, steps, etc.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. A vehicle computer system, comprising:
a processor body structure; and
a processor auxiliary structure detachably connected externally to one side of the processor body structure, wherein the processor auxiliary structure is configured to assist the processor body structure to enhance a computing capability of the vehicle computer system.

2. The vehicle computer system according to claim 1, wherein the processor body structure and the processor auxiliary structure are separated from each other and designed independently.

3. The vehicle computer system according to claim 2, wherein the computing capability of the processor body structure is represented by a computing frequency of the processor body structure, and the computing frequency is lower than or equal to 2.9 GHz.

4. The vehicle computer system according to claim 3, wherein when the need of the computing frequency of the vehicle computer system is higher than 2.9 GHz, the processor auxiliary structure is connected externally to the side of the processor body structure.

5. The vehicle computer system according to claim 1, wherein the processor body structure comprises a central processing unit and a memory, and the central processing unit is coupled to the memory.

6. The vehicle computer system according to claim 1, wherein the processor body structure has a first interface for externally connecting to the processor auxiliary structure, the processor auxiliary structure is inserted in the first interface.

7. The vehicle computer system according to claim 1, wherein the processor body structure has a second interface connecting to a Next Generation Form Factor M.2, and a third interface connecting a peripheral interface, the third interface is configured to connect at least one of a USB or an Ethernet.

8. The vehicle computer system according to claim 1, wherein the system has a system management bus controller, a logic circuit, and a complex programmable logic device, the system management bus controller is coupled to the processor body structure; the logic circuit is coupled to the system management bus controller, and the complex programmable logic device is coupled to the logic circuit.

9. The vehicle computer system according to claim 1, wherein the system has a system management bus controller, and the system management bus controller generates a first signal and a second signal, wherein the first signal is configured to instruct a self-examining boot state of the vehicle computer system, and the second signal is configured to instruct a default state.
